(19) United States
(12) Patent Application Publication
(10) Pub. No.: US 2003/0010724 A1
(43) Pub. Date: Jan. 16, 2003

(54) Waste water aeration apparatus and method

(76) Inventor: Donald Stolarz, Muskegon, MI (US)

Correspondence Address: Waters & Morse, P.C., 400 Ledyard Building, 125 Ottawa, Avenue, NW, Grand Rapids, MI, 49503, US

(21) Appl. No.: 10/167,164

(22) Filed: Jun. 10, 2002

Related U.S. Application Data
(60) Provisional application No. 60/296,784, filed on Jun. 8, 2001.

(51) Int. Cl. B01D 43/00

(52) U.S. Cl. 210/741; 210/808; 210/800

(57) ABSTRACT

A process and apparatus for aerating waste water in order to induce the separation of fat and grease and other substances from waste water comprises the steps of: pumping the water through a diffuser, wherein the air is introduced in small bubbles into the water through a permeable interface positioned between a water chamber and an air chamber; and controlling the pressure of the air across the permeable interface between the air chamber and water chamber, such that a predetermined, relatively low pressure differential pressure exists across the permeable interface. The pressure differential is maintained by a piloted pressure regulator so as to be high enough to cause an adequately large quantity of air to be introduced into the water. The pressure differential is low enough that shear forces tending to dislodge solid particles from air bubbles are minimized. A concentric tubular diffuser maximizes air diffusion into the liquid.

### CROSS-REFERENCE TO RELATED APPLICATION

This application is based on and claims the benefit of the filing date of applicant's co-pending provisional application Serial No. 60/296,784, filed Jun. 8, 2001, which is incorporated herein by reference.

### STATEMENT REGARDING FEDERALLY SPONSORED RESEARCH OR DEVELOPMENT

Not Applicable.

### BACKGROUND OF THE INVENTION

Waste water from slaughterhouses and the like includes solids and suspended fats or grease. Solids can be removed by filtering. Fat or grease, which is saleable, can be removed by permitting it to float to the top of the water in a clarifying tank and then removing the grease from the top by an auger or the like. The remaining, clarified liquid is then transported to an anaerobic pond or bioreactor, wherein biological media remove further impurities from the water. The water is finally discharged.

In order to cause grease to float to the top of the water, a common practice is to aerate the waste water with air bubbles. The grease tends to cling to the air bubbles and floats to the surface of the water. This process is known as aeration and is a common practice in waste water treatment.

One of the challenges in developing an effective aeration system is to maximize the aeration effect on the waste water, so as to maximize the amount of grease that attaches to the air bubbles and floats to the surface. A chemical developed by Dupont known as “Particlear” makes solids easier for bubbles to attach to. Even with Particlear, the manner in which air bubbles are introduced into the waste water is an important factor in the effectiveness of the aeration system.

While a profusion of small bubbles at low pressure is generally considered desirable, in practice this is difficult to achieve. In many waste water treatment systems, air is introduced somewhat crudely by introducing as much air as possible under a fairly high pressure of perhaps 10-25 pounds per square inch higher than the nominal liquid pressure in the waste water conduit. This provides benefits but does not maximize benefits. The high flow rates present with high pressure tend to shear the fats from the air bubbles, reducing the effects of aeration.

An object of the present invention is to provide an improved aeration apparatus and method for aerating waste water in a waste water treatment facility.

### SUMMARY OF THE INVENTION

In accordance with the present invention, an improved aeration apparatus and method for waste water treatment comprises an elongated aeration chamber including a tubular exterior housing and a gas permeable diffuser tube mounted inside the housing and spaced away from the exterior walls of the housing, so as to form a sealed air chamber between the diffuser tube and the housing. A manifold introduces pressurized air into the air chamber. A piloted pressure regulator controls air pressure in the air chamber in relation to the pressure of liquid pumped through the interior of the diffuser tube, such that the differential pressure across the membrane walls of the diffuser tube is maintained at a predetermined, low pressure value that induces air flow at a slow rate and in tiny bubbles from the air chamber through the diffuser tube and into the liquid waste water flowing inside the diffuser tube. The air flow is maintained at a low rate so as to permit substantial amounts of air to pass through the membrane walls of the diffuser while producing fine, low pressure bubbles in the liquid being pumped through the diffuser tube. Multiple aeration chambers in parallel increase the aeration capabilities of the system.

One important advantage of the present invention is that the special construction of the aeration chamber, with the liquid flowing through a small pore size gas permeable tube mounted in the interior of the pressurized air chamber, maximizes surface area for air flow into the waste water. Also, the aeration module is constructed so that the air chamber is sealed effectively and does not leak.

Another very important advantage of the present invention is that the piloted pressure regulator provides a controlled, low pressure air flow that minimizes air bubble size and shear forces that would otherwise be produced by a rapid air flow through the membrane walls. In the present invention, a constant air pressure differential is maintained by the piloted regulator even when water pump pressure varies substantially.

Whereas prior aeration systems have used relatively high air pressures that are not correlated to actual liquid pressures, the present invention uses a consistent lower air pressure based on the differential pressure between the liquid and the air chamber. While optimal pressure differentials are dependent on a number of factors, an operable differential pressure is between about 0.1 and about 8 psi. Desirably, the pressure differential is less than about 7 psi. A pressure differential of about 1 to 5 psi is desirable in some circumstances. The actual desired pressure differential can vary depending upon the characteristics and dimensions of the diffuser tube selected, the rate and volume of liquid flow through the diffuser tubes, and the percentage of waste water aerated. For most applications, a tube of two inches internal diameter and a flow rate of 4½ gallons per minute is desirable.

These and other features of the present invention are described in detail below and shown in the appended drawings.

### BRIEF DESCRIPTION OF THE SEVERAL VIEWS OF THE DRAWING

FIG. 1 is a schematic view showing a waste water treatment facility incorporating the aeration apparatus of the present invention.

FIG. 2 is a plan view of a single aeration chamber of the present invention, showing the manner in which pressure is supplied to the aeration chamber through a constant pressure differential pressure regulator.

FIG. 3 is a fragmentary sectional view of one end of the aeration chamber of FIG. 2.

FIG. 4 is a plan view of the aeration chamber of FIG. 3.

### DETAILED DESCRIPTION OF PREFERRED EMBODIMENT

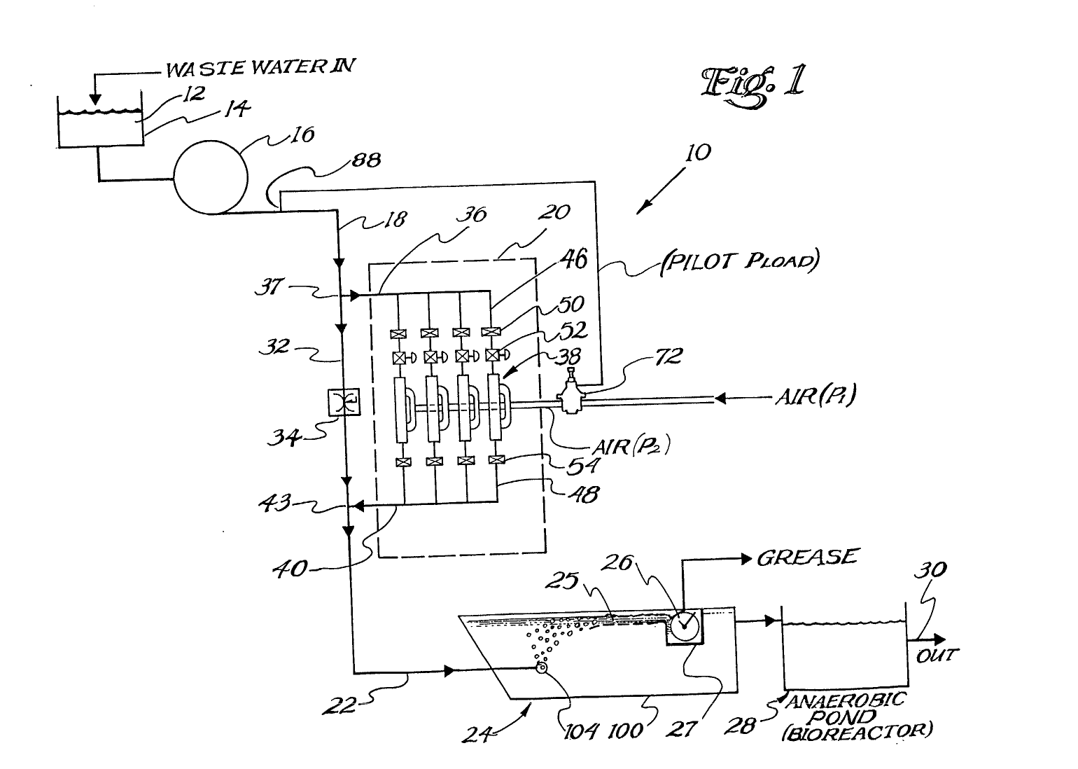

Referring now to the drawings, a typical slaughterhouse waste water treatment facility 10 is shown schematically in FIG. 1. For exemplary purposes, the present invention is described in connection with a slaughterhouse operation. In wastewater treatment facilities, waste water 12 produced in the slaughterhouse is first filtered to remove solid material and then is delivered to tank 14. Pump 16 pumps the water from tank 14 through conduit 18 to aeration apparatus 20 wherein the waste water is aerated. The aerated waste water is then conveyed through conduit 22 to a clarifier or clarifying tank 24, where the aerated liquid causes the fat or grease 25 to float to the surface of the water. The grease is then removed by an auger 26 and the clarified liquid is conveyed to an anaerobic pond or bioreactor 28, wherein biological media consume the remaining impurities in the water so that it can ultimately be delivered for reuse through outlet 30.

In the illustrated system, conduit 32 interconnects conduits 18 and 22. An adjustable flow control valve 34 in conduit 32 creates a pressure drop on opposite sides of the flow control valve. A conduit 36 extends from an inlet 37 upstream of the flow control valve to the inlets of conduits 46 leading to aeration chambers 38, outlets from which extend through conduits 48 to a conduit 40 that connects back into conduit 32 at an outlet 43 on a downstream side of flow control valve 34. Thus, the aeration apparatus causes a portion of the waste water to be bypassed from conduit 32 around flow control valve 34, through aeration chambers 38 and then back to the main waste water conduit. In the preferred practice of the present invention about 20% of the volume of the waste water is diverted through the aeration system. This aerated water is then mixed with the remaining 80% of the waste water, and the air bubbles cause the fat or grease and other solid particulate materials to float to the surface in clarifier tank 24. In certain installations and applications, it may be desirable to aerate more of the waste stream, up to 100% of the waste stream. A lower rate of aeration is possible when a greater portion of the waste is aerated.

In the illustrated embodiment of the invention, aeration apparatus 20 includes four aeration chambers 38 connected in parallel between conduits 36 and 40. The number of aeration chambers can vary with the application. Each aeration chamber is identical, so only one chamber will be described.

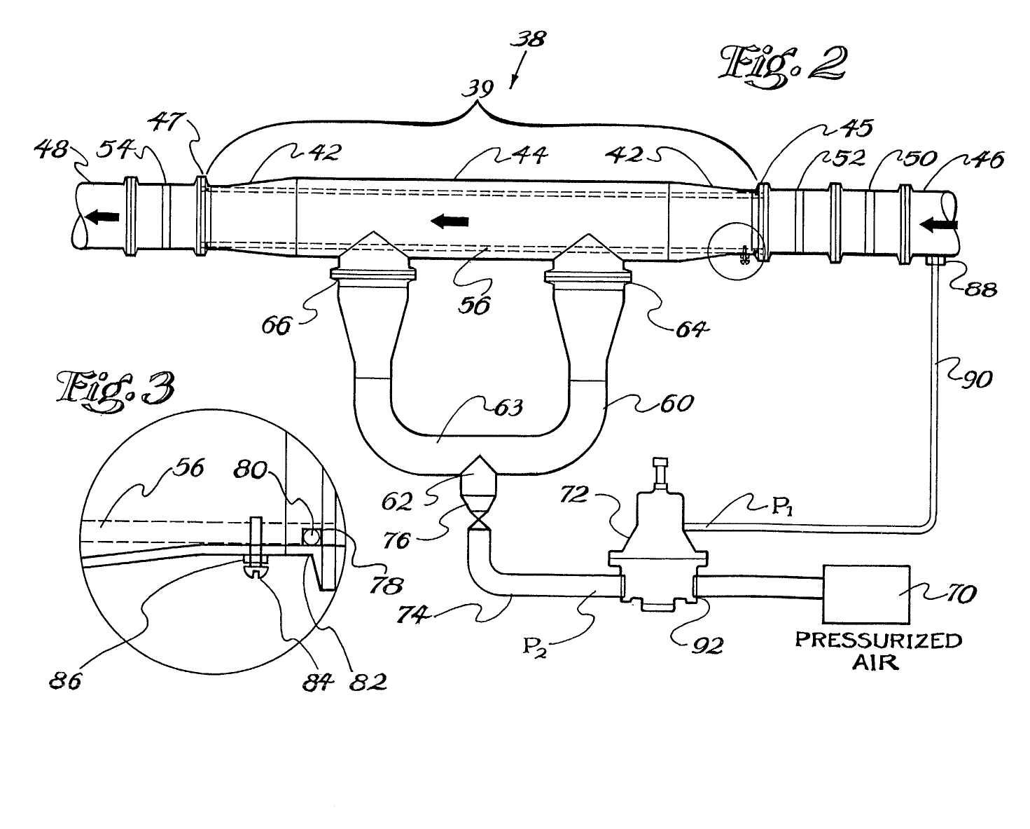

Referring to FIG. 2, chamber 38 comprises an elongated tubular housing 39 about two feet long, having inwardly tapered ends 42 and an enlarged central portion 44. The housing 39 has flanges 45 and 47 at upstream and downstream ends of the housing. The upstream flange 45 of the housing is connected to a solenoid valve 52 and an isolation valve 50, which is in turn connected to conduit 46. The solenoid valve controls the flow of liquid through the aeration chamber and permits the liquid flow to be controlled electrically on a chamber by chamber basis. Downstream flange 47 is connected to an isolation valve 54, which is connected to conduit 48. The isolation valves are manual shut off valves that permit liquid flow to and from the chamber to be stopped so the chamber can be repaired, removed, or replaced.

The interior of chamber 38 is shown in greater detail in FIG. 4. A porous membrane in the form of a plastic diffuser tube 56 extends the length of housing 39. Tube 56 has an outer diameter that is approximately the same as the inner diameter of the housing at the narrow, tapered ends thereof. Since the intermediate or central portion 44 of the housing is of larger diameter than the ends, tube 56 is spaced away from the walls of central portion 44, producing an elongated air chamber 58 that extends for the full length of central portion 44.

Air is introduced into air chamber 58 through an inlet manifold 60, which is a U-shaped tube having an inlet 62 in a middle portion 63 thereof and having ends 64 and 66 connected to central portion 44 at spaced locations thereon.

As shown in FIG. 2, pressurized air is provided from a source 70 to a pressure regulator 72 and then through an outlet conduit 74 to a solenoid 76 and then to inlet 62 in the air inlet manifold 60, where it is introduced into chamber 38 at spaced locations along portion 44 in order to equalize air pressure throughout the chamber.

Diffuser tube 56 desirably is a porous plastic material formed of polyethylene or polypropylene. Porous plastic tubes are commercially available. One satisfactory tube is Porex brand S40CTM porous plastic tube, which is manufactured by Porex Technologies, Fairburn, Ga. The characteristic of the diffuser tube is that the tube is sufficiently porous to permit gas flow through the tube, but the pores are sufficiently small that the tube retains liquid within the tube. A desirable tube is two inch, schedule 40 tube F, having a pore size of about 17-23 microns. This is a standard size tube and is readily available. A tube having a pore size of 45 microns or higher is less desirable because bubbles are less fine. Tubes larger than two inches are less desirable in most cases because a larger tube can acquire more air pressure for air bubbles to penetrate to the waste water at the center of the tube. Thus, a tube of two inches or less is generally more desirable.

With the aeration chamber formed in this manner, the chamber provides a maximum amount of surface area for air diffusion through the walls of the membrane into the liquid flowing through the aeration chamber.

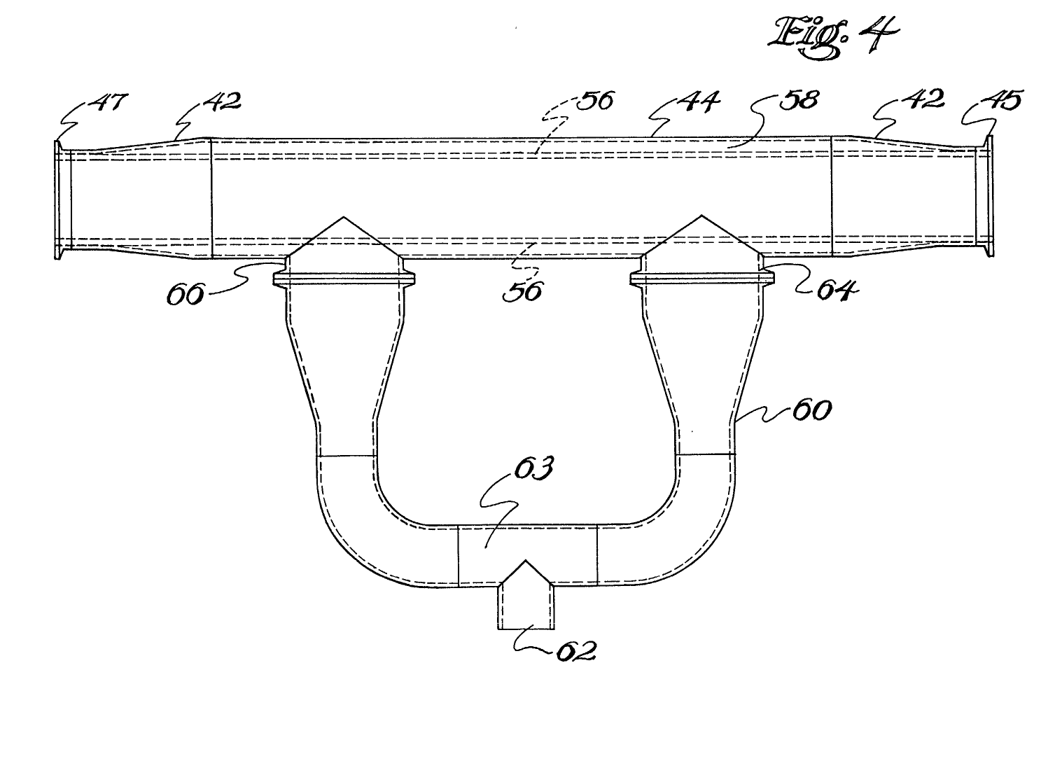

The manner in which the diffuser tube is mounted in the housing for the aeration chamber is shown in FIG. 3. Tube 56 is provided with a groove 78 around the outer peripheral edge adjacent each end, and an O-ring seal 80 fits in the groove, bearing against the end 82 of the housing adjacent the end flange, sealing the air space at each end of the housing. A screw 84 extends through the housing and into the diffuser tube to lock the diffuser tube in place in the housing. A lock nut 86 locks the screw in its tightened position. The screw extends through the housing into the porous tube at the tapered ends of the housing, wherein the tube abuts the housing. The screw thus holds the O-ring seal tightly in place and prevents the diffuser tube from moving. The lock nut holds the screw tightly in its tightened position. The means by which the diffuser tube is mounted in the housing causes the air chamber to be substantially sealed and leak free. Thus, air pressure is not lost through the ends of the housing.

While it is a common objective in many aeration systems to provide small bubbles at low pressure, this objective is generally not achieved. In the present invention, however, extremely fine bubbles are produced at a low pressure, and this induces a maximum aeration effect to the waste water. This is achieved in part by the large available surface area of the diffuser tube and is also achieved by providing a constant and low pressure differential across the diffuser membrane. This is achieved by pressure regulator 72 of the present invention. Most pressure regulators are simply set to achieve a preselected output pressure. In the present invention, the pressure regulator employed is a so-called “piloted” pressure regulator, wherein output pressure through outlet 74 is always maintained at a desired differential from a pilot pressure of the waste water, detected from a remote pressure sensor 88 through a conduit 90.

In the present invention, pressurized air from a source 70 is received by the pressure regulator 72 through an inlet 92. This pressure typically is 90-150 psig.

In the present invention, the output air pressure P2 of the pressure regulator is determined by a pilot signal pressure PI received from pressure sensor 88, which senses the pressure of the waste water entering the interior of the aeration chamber. The pressure regulator maintains the output pressure P2 continuously at a fixed differential with respect to pilot pressure P1. Since pressure P1 represents the liquid pressure in the interior of the diffuser tube, and P2 represents the air pressure in the air chamber on the outer side of diffuser tube 56, the regulator maintains a constant pressure differential across the membrane walls of the diffuser tube. This is an important feature of the present invention, because the pump pressure from pump 16 varies substantially, and it is important to the performance of the present invention that a consistent, low pressure differential be maintained across the walls of the diffuser tube. Whereas in prior aeration systems, large amounts of air have been pumped through the walls of a diffuser or introduced through a pipe orifice in a waste water stream (or otherwise introduced) at a pressure of about 10-25 psi higher than the nominal waste water line pressure, in the present invention, a much lower pressure of preferably about 0.1 to 8.0 psi is maintained across the diffuser tube. The actual pressure differential can vary with the particular diffuser tube employed, but is usually about 1-7 psi. This causes a slow infusion of very fine bubbles of air into the interior of the aeration chamber and maximizes the air bubble surface area throughout the aeration chamber. This slow infusion of the air through the walls of the diffuser tube resembles the bubbles rising in champagne. This minimizes shear forces and induces the fat molecules to adhere to the air bubbles. The pilot operated pressure regulator maintains the pressure differential at the same level, even though pump pressure may vary substantially. Therefore, even though the liquid pump pressure may vary between 5 and 25 psi in a typical installation, a consistent, small pressure differential can be maintained across the walls of the diffuser tube, thus, maintaining a consistent air bubble quality in the aeration chamber at all times.

As a result of the foregoing, waste water treated with the aeration header system of the present invention has a rich, chocolate milkshake appearance, and the aeration bubbles cause maximum separation of saleable fat or grease components from waste water.

Pilot operated pressure regulators of the type used in the present invention are commercially available. One such source of pressure regulators is Cashco, Inc., Ellsworth, Kans.

After the waste water has been suitably aerated, it is conveyed in conduit 22 to clarifier 24, which is shown schematically in FIG. 1. Clarifier tank 24 comprises a tank 100 having an inlet at one end and an outlet at the other end. Conduit 22 discharges waste water into the tank through header 104 mounted at a lower elevation at one end of the tank. The aerated grease 25 floats to the top of the tank and is removed form the tank by an auger 26 positioned in a trough 27 at the other end of the tank. Clarified water is then transferred by conduit 29 to aneroid pond 28 where biological media consume the rest of the impurities before the water is discharged through outlet 30The clarification tank and anaerobic pond can be conventional.

It should be understood that the foregoing is merely exemplary of the preferred practice of the present invention and that various changes and modifications may be made in the arrangements and details of construction of the embodiments disclosed herein without departing from the spirit and scope of the present invention.

I claim:

1. A process for aerating waste water in order to induce the separation of waste products such as fat and grease and other substances from waste water that is pumped through a pipe at a pressure that varies with variations in pump pressure, the process comprising the steps of:
pumping the water through a diffuser, wherein air is introduced into the water through a permeable interface positioned between a water chamber and an air chamber, the permeable interface being constructed so as to cause the air to be introduced into the water in small bubbles;
controlling the pressure of the air across the permeable interface between the air chamber and water chamber, such that a predetermined pressure differential pressure exists across the permeable interface, the pressure differential being high enough to cause an adequately large quantity of air to be introduced into the water, the pressure differential being low enough such that water agitation is minimized and air flow rates are low enough to minimize shear forces caused by the gas flow rates, the shear forces being flow forces tending to dislodge solid particles from air bubbles.

2. A process according to claim 1 wherein the pressure differential is between about 0.1 psi and about 8 psi.

3. A process according to claim 1 wherein the pressure differential is between about 1.0 and 7 psi.

4. A process according to claim 2 wherein the air and water chambers and permeable interface comprise a diffuser member wherein liquid flows from the air chamber through the permeable interface into the liquid as it flows through the diffuser member in a diffuser conduit, a predetermined pressure differential being maintained across the permeable interface by a piloted pressure regulator that senses liquid pressure representative of the pressure in the liquid chamber and causes the air pressure in the air chamber to be maintained at the desired pressure differential in relation to the liquid pressure.
